(19) United States
(12) Patent Application Publication
(10) Pub. No.: US 2005/0025656 A1
(43) Pub. Date: Feb. 3, 2005

(54) Metal part having a dense core and porous periphery, biocompatible prosthesis and microwave sintering

(76) Inventors: Sutapa Bhaduri, Moscow, ID (US); Sarit B. Bhaduri, Moscow, ID (US); Muralithran G. Kutty, Moscow, ID (US)

Correspondence Address: Ormiston & McKinney, PLLC;Suite 400, 802 W. Bannock, P.O. Box 298, Boise, ID, 83701-0298, US

(21) Appl. No.: 10/931,829

(22) Filed: Sep. 1, 2004

Related U.S. Application Data
(62) Division of application No. 10/052,291, filed on Jan. 18, 2002.
(60) Provisional application No. 60/262,730, filed on Jan. 19, 2001.

(51) Int. Cl. A61C 8/00; B32B 3/26

(52) U.S. Cl. 419/52; 428/304.4; 433/206

(57) ABSTRACT

Monoclithic metallic parts having a dense core surrounded by a porous preiphery. Metallic parts having a dense core surrounded by a porous periphery characterized by a multitude of interconnected pores. Dental implants and other prosthesis using such metal parts as a substrate coated with a bioactive material. Microwave sintering a compacted metal powder to produce such parts and prosthesis.

### CROSS REFERENCE TO RELATED APPLICATION

This application claims subject matter disclosed in provisional patent application Ser. No. 60/262,730 filed Jan. 19, 2001 titled Microwave Sintering, Bioactive Coating By Electrodeposition And Osseointegration, which is incorporated herein by reference in its entirety.

### STATEMENT OF RIGHTS TO INVENTIONS MADE UNDER FEDERALLY FUNDED RESEARCH AND DEVELOPMENT

Part of the work performed during the development of this invention was funded by the National Science Foundation under contract no. DMII-0085100. The United States government may have certain rights in the invention.

### FIELD OF THE INVENTION

The present invention is directed to solid metallic parts having a dense core and a porous periphery and microwave sintering techniques used to form such parts

### BACKGROUND

Osseointegration is the formation of a direct structural and functional bond between living bone and the surface of an implant without any intervening soft tissue. Osseointegrated dental implants have been used since the early 1980s in the restoration of toothless people all over the world. Several factors influence the success of osseointegration, including the strength, elasticity, surface composition, biocompatibility and design of the implant and the surgical techniques used for implantation.

Osseointegrated dental implants are usually made out of titanium. FIG. 1 illustrates a typical titanium dental implant 10. FIG. 2 is a partial cut-away view showing implant 10 after implantation. As shown in FIG. 2, implant 10 is embedded in bone 12 with surrounding gum 14. New bone growth 16 occurs in the region immediately around implant 10. The crown or artificial tooth is cemented to abutment 18 which screws in to implant 10.

Presently, titanium dental implants are machined out of titanium and titanium alloys. Some implants are plasma spray coated with titanium or hydroxyapatite. Hydroxyapatite is a material found in bone and naturally promotes a biochemical bond with osseous tissues. The plasma spray process melts fine particles, typically 30 nm to 50 nm, at high temperatures, about 3000° C., and provides a porous surface on the implant. Bone tends to appose to this porous structure. However, due to the presence of undesirable phases, plasma spraying of hydroxyapatite is only partially effective in the osseointegration process. The porous coating by itself does not have enough strength. Strength is provided by a monolithic structure underneath the coating. Further, it is important to have the right surface composition for proper osseointegration. While conventional implants are machined and turned at room temperature, plasma spraying exposes the surfaces to much higher temperatures. The surface obtained by machining is smoother than the surface obtained by plasma spray coating.

Conventional methods for fabricating titanium and other metallic implants include investment casting, computerized manufacturing, forging, and powder metallurgy. In most cases, the final product is formed by machining the raw product. The risk of surface damage during machining is a disadvantage because surface damage can appreciably lower the fatigue life of the implant. Titanium is one of the most difficult materials to machine. Titanium is chemically reactive and has a tendency to weld to the tool during machining, which leads to premature tool failure. Its high reactivity limits the use of state-of-the-art ceramic tools. The low thermal conductivity of titanium increases the temperature at the interface of tool and work piece, reducing the effective life of the tool. The low elastic modulus of titanium permits deflections of the work piece and, therefore, requires proper backup. As a result of these difficulties, titanium should be machined using low cutting speeds, maintaining high feed rates, spraying generous quantities of cutting fluid and maintaining sharp tools and rigid setups. Even if these precautions are taken, machining titanium ingots still can not produce interconnected surface pores.

In spite of the machining difficulties, titanium is still the most popular material for dental implants. Electrochemical machining, chemical milling, and laser beam-machining have been tried recently in an attempt to avoid the difficulties encountered during conventional machining of titanium. Electrochemically machining or chemically milling an intricate contour shape like a dental implant is difficult. Laser beam machining is an effective technique for making intricate contour shapes, but it requires special equipment and may not be cost effective for the commercial production of titanium dental implants.

Biocompatibility is another important consideration in the fabrication of metal implants. The optimum biocompatible implant is non-toxic, inert, stabile, and noncarcinogenic. Fabrication conditions can affect biocompatibility. A metal can be non-toxic but unstable, corroding in body fluids. Corrosion results in the loss of implant materials, which eventually weakens the implant. Corrosion debris that escapes from the corroded surface can penetrate the body. A porous surface helps osseointegration but may increase the risk of corrosion. Also, pores may trap machining debris and cutting fluids. Bioactive coatings on implants are desirable. As an intermediate between resorbable and bioinert materials, bioactive coatings promote bonds between tissues and the implants. Also, a bioactive coating can prevent corrosion of porous metal.

Hydroxyapatite can provide the desired bioactivity on the implant surface. Hydroxyapatite is a ceramic and hence a brittle material. The fracture toughness of synthetic hydroxyapatite is 0.8-1.2 MPa. √m with an average of 1 MPa.√m. Human bone has a fracture toughness of 2-12 MPa.√m. Presently, hydroxyapatite ceramics cannot be used as monolithic implants, such as those used for teeth and bones. If the calcium to phosphorous (Ca/P) ratio is lower than 1.67, α and β tricalcium phosphates (TCPs) form. However, with a low Ca/P ratio, the strength increases. The presence of tricalcium phosphate in hydroxyapatite increases biodegradability and susceptibility to slow crack growth. The Weibull modulus of dense hydroxyapatite is reported to be between 5 and 18. Slow crack growth coefficients (n) vary greatly from 12-49 under wet conditions to 26-80 under dry conditions. Grain boundaries with Ca/P ratio lower than that of hydroxyapatite are especially susceptible to slow crack growth. Vickers hardness of dense hydroxyapatite is 3-6 GPa and Young's modulus is 44-88 GPa. This data indicates that in its monolithic form hydroxyapatite is not suitable as an implant. Furthermore, the production of a dense walled but openly porous structure with the correct ratio of Ca/P using hydroxyapatite would be very challenging.

As far as the development of a porous hydroxyapatite implant goes, White and Schors developed the “Replamineform” process to duplicate the porous microstructure and interconnection found in natural corals. The primary advantage of this process is that the pore sizes and microstructure are uniform and controlled. Also, there is complete interconnection between the pores. In terms of mechanical properties, such porous materials are weaker than their bulk counterparts. As surface area increases in porous ceramics, effects of the environment on decreasing strength become more predominant. In order to compensate for strength degradation, these porous ceramics require bone growth to stabilize the implant. So, in spite of excellent biocompatibility, hydroxyapatite may not be the best choice as a porous monolithic implant material because of its poor mechanical properties and aging behavior.

Strategies for utilizing hydroxyapatite as a successful implant material include adding other ceramic reinforcements to hydroxyapatite, coating a biocompatible metal with hydroxyapatite, or making hydroxyapatite/polymer composites. Coating a metallic substrate with hydroxyapatite has several benefits. Coating provides stable fixation of the implant by precision fit to the bone and minimizes adverse reaction. Hydroxyapatite coatings decrease the release of metal ions of the implant into the body and shield the metal surface from environmental attack. A porous hydroxyapatite coating facilitates bone growth through a highly convoluted interface. When pore sizes exceed 100 μm, bone grows through the channels of interconnected surface pores, thus maintaining the bone's vascularity and viability. Porosity also helps provide a smooth blood supply to promote the in-growth of connective tissues. Composition, crystal structure, and ultrastructure also affect implant-tissue interaction. The hydroxyapatite coating should be approximately 40-200 μm thick to resist resorbability of hydroxyapatite, it should be porous to facilitate bone growth, and it should not contain impurities.

### SUMMARY

The present invention was developed in an effort to help provide a bioactive dental implant that will promote regeneration of surrounding tissues. As part of this effort, we discovered that microwave sintering could be used to produce new metallic structures particularly suited for use as dental implants and other prosthesis. Accordingly, one embodiment of the invention is directed to a solid part that includes a metallic monolith having a dense core surrounded by a porous periphery. In another embodiment, the solid part includes a shaped metallic structure having a dense core surrounded by a porous periphery characterized by a multitude of interconnected pores. These parts are new in at least two respects—the monolithic nature of the part and interconnectedness of the pores. Conventional methods used to produce metal parts having a dense core and porous periphery require multiple steps in which materials are added or removed and, hence, conventional processes do not and cannot yield monolithic structures, nor do they result in interconnected pores.

The preferred dental implant includes a bioactive coating on a monolithic titanium or other suitable metallic substrate having a dense core and a porous periphery. The substrate provides strength while the bioactive coating improves tissue response and bone growth.

Another embodiment of the invention is directed to the use of microwave sintering to form the desired structure. In this embodiment, titanium or another suitable metal powder is compacted into the general shape desired and then exposed to microwaves under conditions sufficient to transform the compressed powder into a monolith having a dense core surrounded by a porous periphery. If a bioactive coating is desired, hydroxyapatite or other suitable bioactive coatings may be applied by electrocrystallization.

### DESCRIPTION OF THE DRAWINGS

FIG. 1 is a perspective view of a typical metallic dental implant.

FIG. 2 is a partial cut-away view showing a dental implant after implantation.

FIG. 3 is a schematic sectional representation of an implant having a dense core surrounded by a porous periphery and a bioactive coating.

FIG. 4a is a schematic representation of a microwave furnace system.

FIG. 4b is a schematic representation of one preferred arrangement for a substrate during microwave sintering.

FIG. 5 is a schematic representation of an electrocrystallization system for applying a bioactive coating to a substrate.

FIG. 6 is a photograph of a near net shape screw shaped titanium substrate after microwave sintering.

FIGS. 7a and 7b are micrographs showing in section the different porosity distributions of the dense inner core and the porous periphery of a titanium substrate.

FIG. 8 is a higher magnification micrograph in section showing the porosity distribution along the periphery of a titanium substrate.

FIG. 9 is a micrograph of the surface of a titanium substrate showing interconnected open pores.

FIG. 10 is a graph showing the distribution of the pores as a function of distance from the surface.

FIG. 11 is an X-ray diffraction pattern of a hydroxyapatite coating.

FIG. 12 is a micrographic surface view of a hydroxyapatite coating.

FIG. 13 is a micrographic side view of a hydroxyapatite coating.

FIG. 14 is a series of micrographic maps of calcium and phosphorous showing the extent of a hydroxyapatite coating.

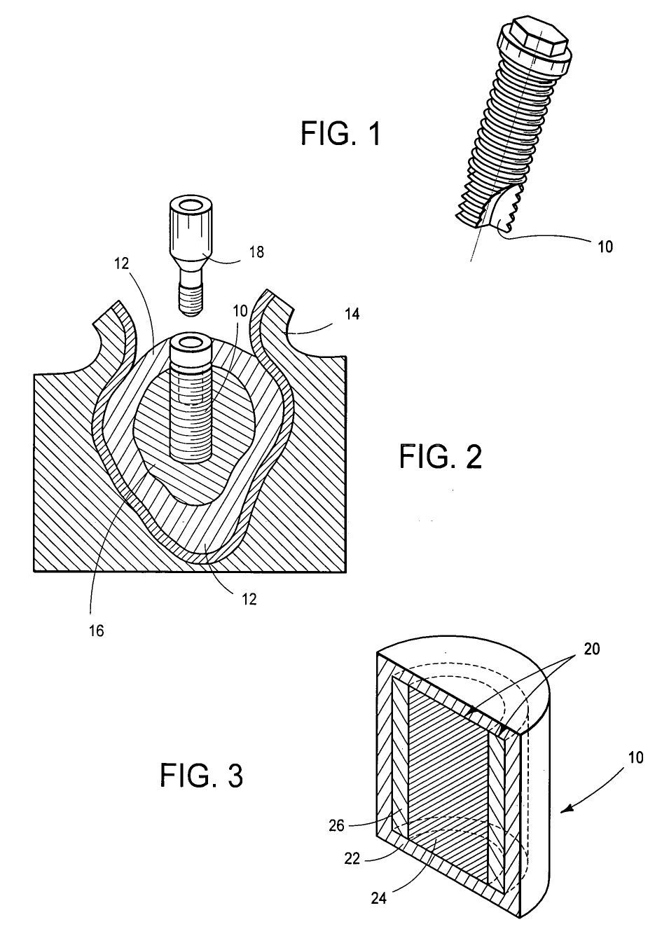

### DETAILED DESCRIPTION

In conventional processing, slow heating rates and a great deal of insulation are used to sinter metallic powders to full density. We have discovered, however, utility in the exactly opposite conditions, i.e., we intentionally use fast heating rates and less insulation. The overall effect is a gradient in temperature with an inverse sintered density profile. This leads to the desired monolithic implant substrate—a dense core surrounded by a porous periphery.

Since the processing techniques of the present invention involve microwave energy a brief background of microwaves is presented. Microwaves are electromagnetic radiation with wavelengths ranging from 1 mm to 1 m in free space. In the United States, frequencies of 915 MHz and 2.45 GHz are assigned to microwave operation. Microwaves are believed to be reflected by metals, although this is not always true. Certain minerals and ceramics absorb microwaves and become self-heated. Microwave absorption generates heat in-situ. Microwave energy is more energy efficient than conventional heating. The power deposited into a material is given by P=2πƒεₒεᵣ tan δE² where f is the frequency, εₒ is the permittivity of the free space, εᵣ is the relative permittivity, tan δ is the loss tangent, and E is the electric field. The desired porosity profile is achieved by utilizing how microwaves are coupled in metal powders. Due to the high electrical and thermal conductivity of metallic powders, even though microwaves are coupled within the central portion of a part, the heat generated is quickly dissipated.

FIG. 3 is a schematic sectional representation of the preferred structure of one embodiment of the implant of the present invention. Referring to FIG. 3, implant 10 includes a monolithic substrate 20 and a bioactive coating 22. Substrate 20 has a dense core 24 surrounded by a porous outer region 26. Outer region 26 is also referred to herein as the periphery of substrate 20. Monolithic substrate 20 provides reasonable strength while coating 22 enhances bioactivity upon implantation to stimulate bone growth. Although a coating 22 of hydroxyapatite or another suitable bioactive material is preferred for enhanced bioactivity, the uncoated monolithic substrate 20 with its dense core 24 and porous periphery 26 could be used for the implant. Implant 10 refers generally to any of various embodiments of the implant of the present invention. Therefore, in the case of an uncoated implant, the term “substrate” is not appropriate and the monolithic structure would be referred to directly as the implant.

One innovation of the present invention arose from our serendipitous discovery of a microwave sintering process for making titanium with a dense core surrounded by a porous periphery. One of our objectives was to fabricate near net shape titanium dental implants with limited surface porosities. Rather than machining titanium ingots, we pursued a powder metallurgy approach. Creation of surface porosities along with a dense central core by means of microwave sintering provides adequate strength while facilitating bioactive coating penetration. This has not been possible by conventional sintering in a furnace.

In one preferred process, the desired structure is obtained by pressing and subsequently densifying commercially pure titanium powder. Although the process will be described with reference to the fabrication of the screw shaped titanium dental implant shown in FIG. 6, the process may be used to produce other shapes and with other metallic powders. Titanium powder is green compacted at about 20 Ksi in a mold of the desired size and shape in a cold isostatic press. If the implant is to be constructed as a coated substrate, then the mold will reflect the size and shape of the uncoated substrate. If the implant is to be uncoated, then the mold will more nearly reflect the final size and shape of the implant.

The preferred initial titanium particle size is less than −325 mesh in order to enhance reactivity. A binder may be used as necessary or desirable to give some handling strength to the titanium powder. The binder is removed after pressing by slowly heating the implant to about 200° C. and keeping it at that temperature for 1-1.5 hours. Heating the implant in a vacuum furnace backfilled with argon (Ar) will help prevent surface oxidation during removal of the binder.

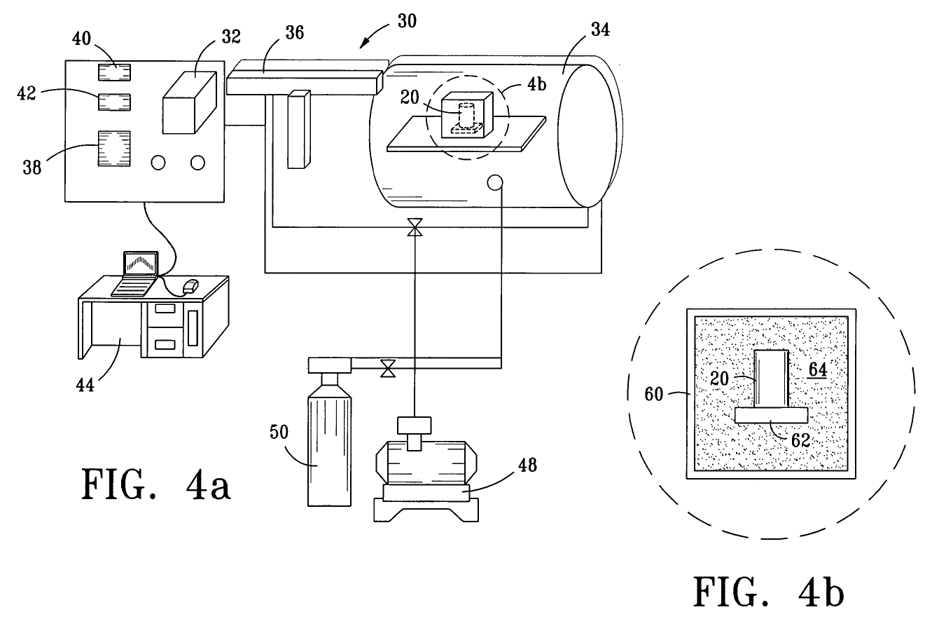

The implant is densified by microwave sintering in a microwave furnace system 30 such as the one shown schematically in FIG. 4a. Referring to FIG. 4a, a typical system 30 includes a magnetron 32 operatively coupled to a furnace cavity 34 through a wave guide 36. Furnace controller 38 coupled to forwarded power supply 40, reflected power supply 42 and magnetron 32 controls the output of magnetron 32 at the direction of controlling computer 44. Magnetron 32 should have a variable power output from 0 to 3 kW at 2.45 GHz. It is desirable that the output of magnetron 32 be set and stabilized using a feedback loop with saturable reactors in the primary circuit of the high voltage magnetron power supply. Preferably, furnace cavity 34 is about 10 times the wave length of the electromagnetic radiation, which has a wave length of about 12.5 cm. Hence, cavity 34 is said to be “overmoded.” A relatively large sized cavity enhances the mixing of the incoming microwave pattern with the reflected pattern. An optical pyrometer 46 measures the temperature of materials in cavity 34 and provides temperature feedback to controller 38.

The atmosphere inside the vessel is controlled with a vacuum pump 48 and a supply of argon or other insert gas 50. Vacuum pump 48 removes air from cavity 34 as necessary or desirable while an inert gas is introduced into the evacuated cavity from tank 50.

FIG. 4b shows one preferred arrangement for substrate 20 during microwave sintering. Referring to FIG. 4b, substrate 20 is placed in cavity 34 in an aluminum oxide (Al₂O₃) fiberboard box 60. The aluminum oxide fibers are low density and insulating but not significantly absorptive at the operating frequency. The box preferably also contains strips of dense silicon carbide (SiC) to act as a susceptor 62. Substrate 20 is surrounded by alumina fiber blankets 64. Insulation 64 insulates substrate 20 against overheating from direct contact with susceptor 62, prevents any diffusion of carbon from the silicon carbide susceptor 62 into the metallic substrate 20 and appears to be important in the creation of an inverted temperature gradient in substrate 20.

For a titanium dental implant size substrate 20, such as the one shown in FIG. 6, the substrate 20 is exposed to microwaves at 1.0-2.5 kw for not more than 20 minutes in a 10 cm×10 cm box 60. Substrate 20 is surrounded with 14-30 grams of insulation 64. In this arrangement, substrate 20 heats rapidly, about 50° C. per minute, to 1200° C.-1400° C. Alumina fiber is the preferred insulator because it is a good insulator and does not couple microwave energy. Microwaves are coupled in the interior of substrate 20 while the surface dissipates the heat faster. Thus, an inverted temperature gradient is generated in substrate 20 such that the temperature in the core of substrate 20 is greater than the temperature at the periphery. Porosity results from temperature differences between the core and the periphery. In conventional sintering, products are usually denser at the periphery because the periphery is heated first and most and the core remains porous unless some pressure is applied along with the heat. In microwave sintering, substrate 20 absorbs the microwave energy in the core first, to heat the core, and then at the periphery. Heat is also dissipated faster at the periphery than at the core. Less insulation allows greater but controlled heat dissipation for greater porosity while more insulation slows heat dissipation for a more dense structure with fewer pores.

While it is expected that the values noted above for the microwave sintering processing parameters may be varied somewhat as necessary or desirable to accommodate different size and shape substrates or different metallic powders, the processing parameters should be set at values that will create the inverted temperature gradient that allows for the formation of the desired density variation within the substrate.

After microwave sintering, substrate 20 is washed in an ultrasonic bath, dried, and slightly etched in nitric acid (HNO₃) solution before the bioactive coating is applied. Etching cleans the pores to promote infiltration during electrodeposition.

The preferred bioactive coating material is hydroxyapatite and the preferred form of electrodeposition is electrocrystallization. In the literature, there are many references for coating metallic substrates with hydroxyapatite. These include plasma spraying, sol-gel, flame spraying, chemical vapor deposition, sputtering, laser ablation, bio mimicking, hydrothermal and electrodeposition. Plasma spraying is the most common process for producing hydroxyapatite coatings. Plasma spraying has advantages as well as disadvantages. The advantages are: 1) plasma spray produces high temperature at which hydroxyapatite particles melt and form strong bonds to the substrate and, therefore, no post annealing is needed; 2) plasma spray is a fast process for building up layers; and 3) no protective atmosphere is needed for plasma spraying hydroxyapatite coating. The disadvantages of plasma spaying are: 1) prolonged high temperature exposure may alter the microstructure of the substrate; 2) hydroxyapatite is unstable at high temperature and may decompose to calcium oxide, tricalcium phosphates, and other phosphates; 3) because plasma spraying is a line-of-sight process, the coating may not penetrate the pores of base metal; and 4) due to the non-equilibrium nature of the technique, amorphous phases may be present—the amorphous phases tend to resorb somewhat easily; and 4) most importantly, it is difficult to produce a porous coating by plasma spraying.

Therefore, other techniques were examined. Flame spraying generates higher particle velocities and lower temperatures using a high velocity oxy-fuel (HVOF). Sol-gel, magnetron sputtering, and laser ablation are slow processes for building up the requisite layers of suitable thickness. Both bio-mimicking and electrodeposition have been reported in the literature and are relatively easier to use for thick coatings. The electrodeposition technique is simpler than the bio-mimicking process. The electrodeposition technique encompasses both electrophoretic deposition and electrocrystallization. In the first case, the synthetic hydroxyapatite powders are dispersed in a proper liquid medium. The substrate to be deposited is connected to an electric potential to create an electric field. This causes electrophoresis to occur and hydroxyapatite is deposited on the substrate. After deposition, the as-coated films need annealing. As opposed to electrophoresis, the electrocrystallization technique deposits the coating from a solution of reactants such as Ca(NO₃)₂ and NH₄H₂PO₄ to produce hydroxyapatite. Electrocrystallization was introduced by Redepenning et al. and Shirkhanzadah who prepared phosphate coatings on titanium alloy at a relatively low temperature. In their method, phosphates are deposited on the cathode as a result of pH increase in the vicinity of the cathode. Because of H₂ generation, electrocrystallization should be restricted to producing porous films. The deposition also depends on concentration of suspension, time of deposition, surface area of deposit, and electric field. These coatings benefit from a low temperature calcination process to crystallize the hydroxyapatite. This cuts down a processing step and enhances capability to coat porous substrates without clogging the pores. There are several advantages of this electrocrystallization process: 1) it is a non-line-of-sight process and can be used to coat substrates of complex shapes (as is the case here) e.g., fewer size and shape limitations; 2) this process has high deposition rates; and 3) it requires a low initial capital investment. The only disadvantage of this process as opposed to thermal spraying is that the coating must be heat treated after deposition. Hence, we chose electrocrystallization as the preferred method for applying a hydroxyapatite coating.

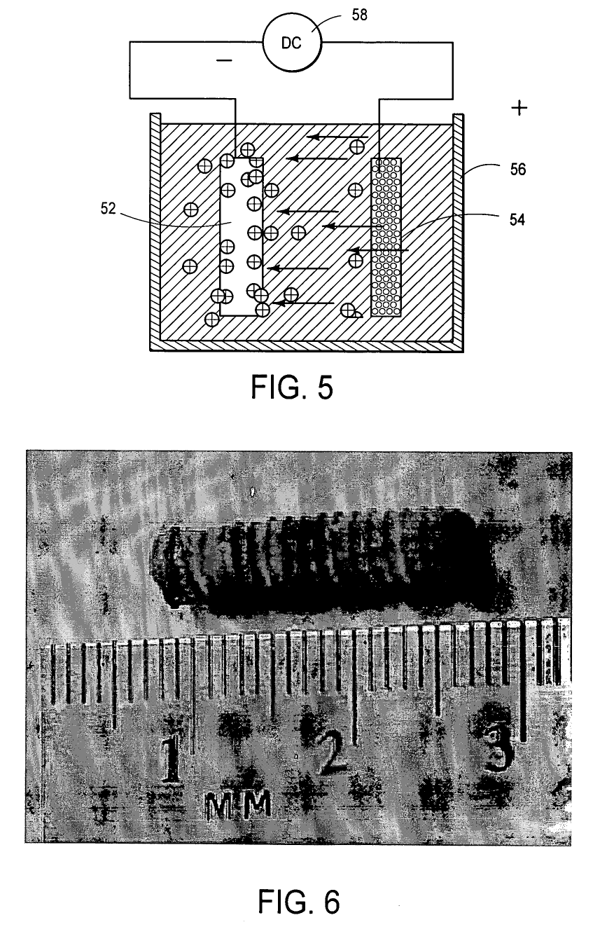

One electrolyte used for the application of the hydroxyapatite coating is made by mixing 0.042M Ca(NO₃)₂, and 0.025M NH₄H₂PO₄ solutions. The solutions were prepared by mixing 50% ethanol with 50% deionized water. The ethanol appears to minimize cracks and excess pores by inhibiting the formation of hydrogen (H₂) bubbles. The electrocrystallization system arrangement is shown in FIG. 5. Referring to FIG. 5, the electrocrystallization coating process is carried out at about 69° F. using substrate 20 as the anode 52 and a stainless steel cathode 54. A magnetic stirrer should be used throughout the coating process so that no precipitate can deposit at the bottom of container 56. A variable power supply 58, such as the Elanco precision model XP-650 dual variable power supply, is used to control the voltage and current. Voltages between 15 and 25 V and currents of 0.5-1.5 amps applied for 5-20 minutes should be adequate for coating a typical dental implant. The following processing parameters may be varied to obtain the desired coating—composition, time duration, pH level of electrolyte, current density, and the voltage applied. The coated substrates should be allowed to dry slowly, for example air drying over night, and then calcined at 100° C. to 400° C.

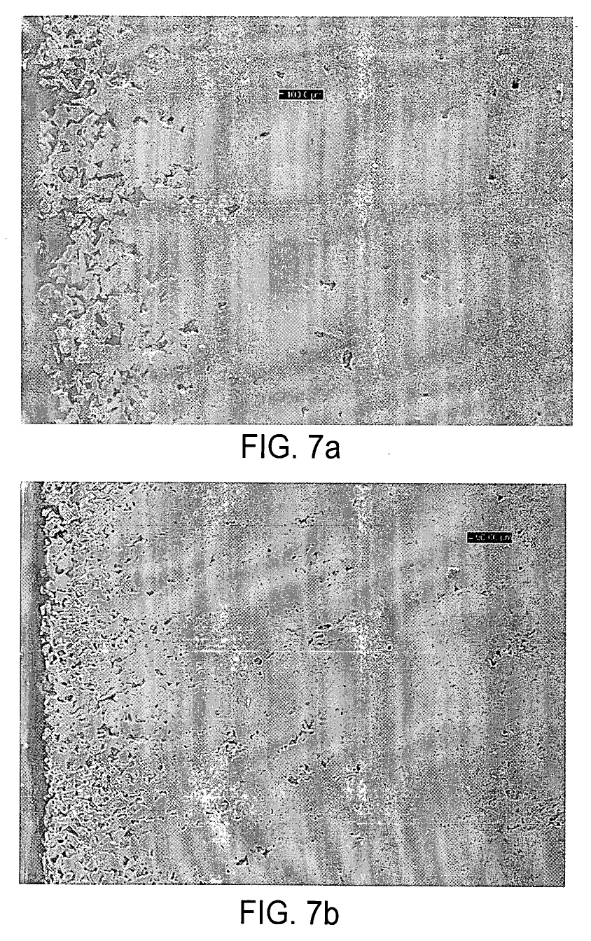

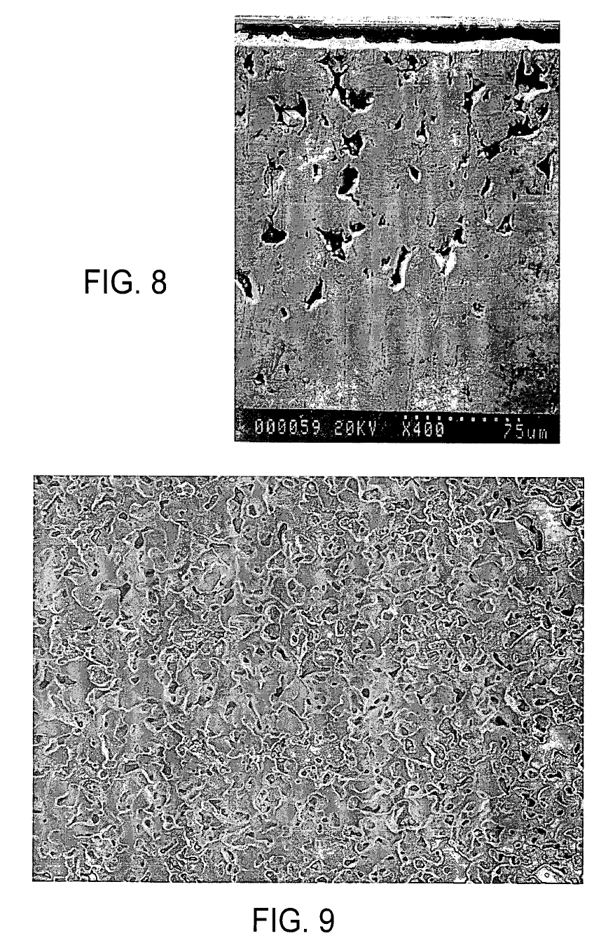

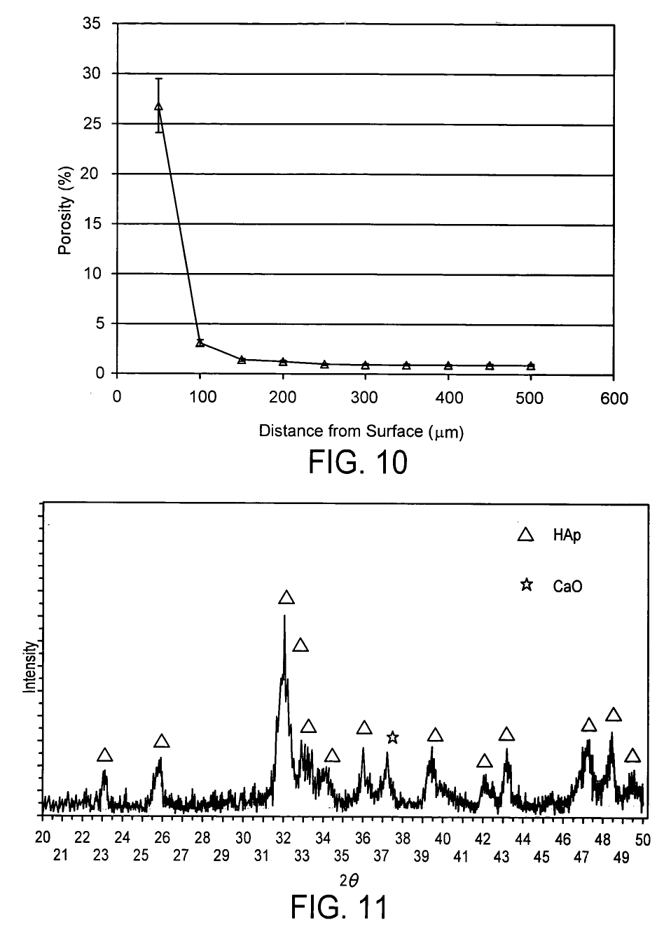

FIG. 6 is a photograph of a near net shape screw shaped titanium substrate 20 after microwave sintering. FIGS. 7a and 7b are scanning electron microscope (SEM) micrographs showing in section the different porosity distributions of the dense inner core 24 and the porous periphery 26. The porous periphery is the blotchy area along the left side of each micrograph. FIG. 8 is a higher magnification SEM micrograph in section showing the porosity distribution along the periphery 26 of substrate 20. FIG. 9 is an SEM micrograph of the surface of a titanium substrate showing that the porous periphery 26 includes a distribution of interconnected open pores. Pores in the periphery are circular with an average size of 100-150 μm. FIG. 10 is a graph showing the distribution of the pores as a function of distance from the surface. The porosity of substrate 20 drops sharply from 25%-30% porosity at the surface to less than 5% 100 μm from the surface.

FIG. 11 shows an X-ray diffraction pattern of the calcined coating. Nearly the entire pattern can be attributed to the presence of hydroxyapatite. Because of the very low calcining temperature, the peaks were broad due to the presence of fine crystallites. This pattern is similar to the hydroxyapatite that occurs naturally in bones and teeth.

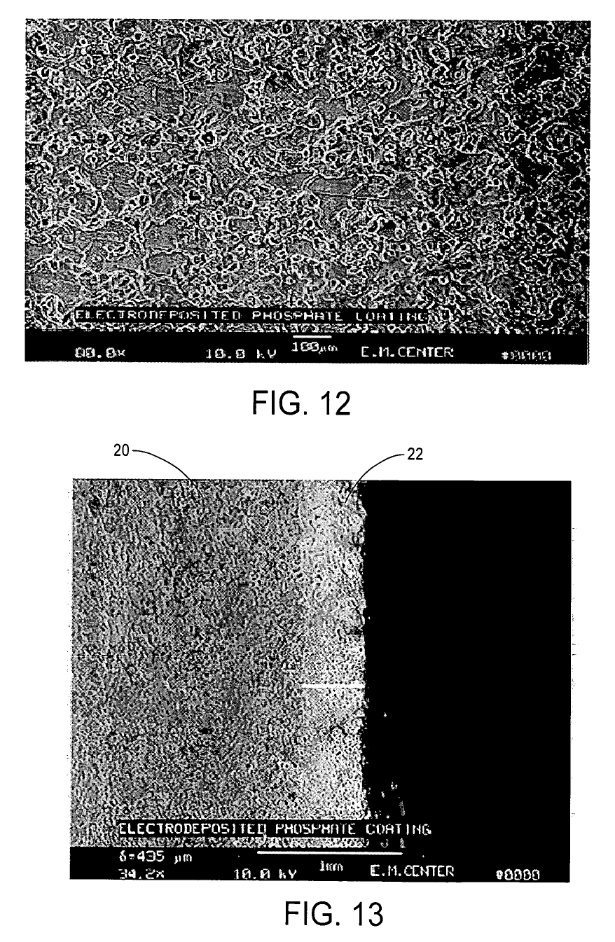

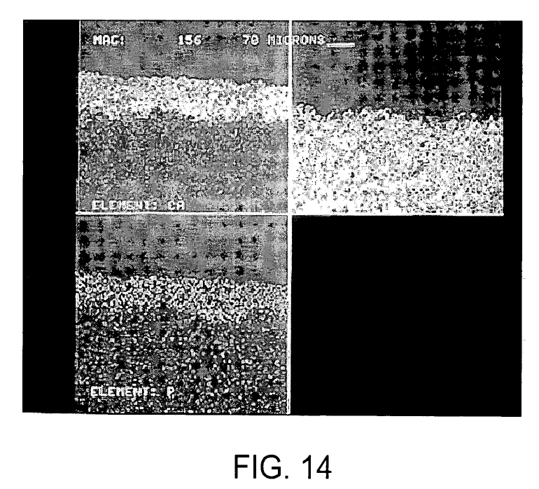

A surface view of the hydroxyapatite coating containing the porous feature of the substrate is shown in FIG. 12. Pores are visible because the coating material penetrates but does not clog the pores. The presence of interconnected pores improves the penetration of the coating material. FIG. 13 is a side view of the coating 22 on substrate 20. As seen in FIG. 13, the coating thickness is about 435 μm. The preferred coating thickness for a typical dental implant is 40-200 μm. FIG. 14 shows elemental maps of Ca and P taken with a scanning electron microscope to identify the extent of coating deposition. The coating appears brighter than the substrate.

The present invention has been shown and described with reference to the foregoing exemplary embodiments. Other embodiments are possible. It is to be understood, therefore, that these and other forms, details, embodiments and variations may be made without departing from the spirit and scope of the invention which is defined in the following claims.

1-15. (canceled).

16. A method, comprising:
compacting a metal powder; and
exposing the compacted powder to microwaves under conditions sufficient to transform the compressed powder into a monolith having a dense core surrounded by a porous periphery.

17. The method of claim 16, wherein exposing the compacted powder to microwaves under conditions sufficient to transform the compressed powder into a monolith having a dense core surrounded by a porous periphery comprises exposing the compacted powder to microwaves at 1.0 kilowatt-2.5 kilowatts for not more than 20 minutes.

18. A method, comprising:
transforming metal powder into a monolith having a dense core surrounded by a porous periphery; and
coating the monolith with a bioactive material.

19. A method, comprising:
pressing titanium powder into a desired shape;
exposing the compressed powder to microwaves under conditions sufficient to transform the compressed powder into a monolith having a dense metal core surrounded by a porous metal periphery; and
coating the periphery with hydroxyapatite.

20. A method, comprising:
compacting titanium powder without external heating;
microwave sintering the compacted powder to form a substrate; and
depositing hydroxyapatite on the substrate.

21. A method, comprising:
compacting titanium powder without external heating;
microwave sintering the compacted powder to form a substrate having a dense core surrounded by a porous periphery; and
depositing hydroxyapatite on the periphery of the substrate.

22. A method, comprising:
compacting titanium powder into a desire shape without external heating, the shape having a core and a periphery surrounding the core; and
sintering the compacted powder including heating the core to a temperature greater than the temperature in the periphery.

23. The method of claim 22, wherein sintering comprises exposing the compacted powder to microwaves.

24. A method, comprising:
compacting a metal powder into a desired shape;
sintering the compacted powder with microwaves to form a sintered substrate; and
electrodepositing a bioactive material on the substrate.

25. A method, comprising:
compacting titanium particles having a particle size less than 325 mesh into a desired shape;
thermally insulating the compacted powder;
exposing the insulated compacted powder to microwaves at 1.0 kilowatt-2.5 kilowatts for not more than 20 minutes to form a sintered substrate;
electrocrystallizing hydroxyapatite on the substrate; and
calcining the coated substrate.

26. A method, comprising:
compacting titanium particles having a particle size less than 325 mesh into a desired shape;
thermally insulating the compacted powder;
exposing the insulated compacted powder to microwaves at 1.0 kilowatt-2.5 kilowatts for not more than 20 minutes to form a sintered substrate;
washing the substrate in an ultrasonic bath;
drying the substrate;
etching the substrate in nitric acid;
immersing the substrate as an anode in an electrolyte that includes Ca(NO₃)₂, and NH₄H₂PO₄;
immersing a cathode in the electrolyte;
generating 0.5 to 1.5 amperes of electrical current between the anode and cathode for 5-20 minutes to form a coated substrate;
drying the coated substrate; and
calcining the coated substrate at 100° C. to 400° C.
